(19) United States
(12) Patent Application Publication
(10) Pub. No.: US 2023/0072880 A1
(43) Pub. Date: Mar. 9, 2023

(54) METHOD OF REMOVING IMPURITIES IN DESIGN ALCOHOLIC BEVERAGES

(71) Applicant: Yakov Shteyman, Brooklyn, NY (US)

(72) Inventor: Yakov Shteyman, Brooklyn, NY (US)

(21) Appl. No.: 17/988,437

(22) Filed: Nov. 16, 2022

Related U.S. Application Data
(63) Continuation of application No. 16/409,160, filed on May 10, 2019.
(60) Provisional application No. 62/670,356, filed on May 11, 2018.

(51) Int. Cl. C12H 1/07; C02F 1/52; C12G 3/08

(52) U.S. Cl. CPC C12H 1/063; C02F 1/52; C12G 3/08

(57) ABSTRACT

A method for removing a set of impurities in an alcoholic beverage includes the steps of providing a water solution including approximately 96%, or less, of pure water and at least 4% or more of honey by volume, creating a mixture from approximately 50% the water solution by volume and approximately 50% by volume of a spirit base that includes a set of impurities and at least 80% alcohol by volume, adding approximately 4% or more of a solids reactive surface by volume to create two phase colloidal mixture, adsorbing the set of impurities with the solids reactive surface, re-suspending the solids reactive surface in the mixture from the sedimentation, adding approximately 1% of a set of extracts by volume to the resultant product to achieve desired taste, and separating the sedimentation from the resultant product.

### CROSS-REFERENCE TO RELATED APPLICATIONS

This application is a continuation application of U.S. Application No. 16/409,160, filed May 10, 2019, which claims priority to U.S. Provisional Application No. 62/670,356, filed May 11, 2018. Each of these patent applications is incorporated herein by reference in its entirety to provide continuity of disclosure.

### FIELD OF THE INVENTION

The present invention relates to food and beverage processing. In particular, the present invention relates to processing alcoholic beverages by removing contaminants and impurities and achieving desirable designed taste and aroma of beverage by adding variable plant extracts.

### BACKGROUND OF THE INVENTION

Alcoholic beverages, in particular distilled spirits, begin with a fermentation process, which converts sugars into cellular energy thereby producing ethanol and carbon dioxide. Another byproduct of fermentation is fusel oil produced by amino acids during the fermentation and distillation process.

Fusel oil is a mixture of volatile organic acids, higher alcohols, aldehydes, ketones, fatty acids, and esters, including amyl alcohol and n-propyl and isobutyl alcohols. When concentrated, this mixture has an oily consistency and potent odor. During distillation fusel oil are typically concentrated in the feints or “tails” at the end of the distillation run. Fusel oil can affect the flavor and aroma of the resultant beverage. For example, fusel oil can give off a solvent-like aroma and flavor. Moreover, in certain beverages such as vodka the presence of fusel oil, in addition to alcohols other than ethanol, is considered a fault. As a result, removal of these impurities including fusel oil is desirable.

One proposed method employs nanofiltration and ultrafiltration to filter out the fusel oil. However, this method is limited to rice spirits and requires additional costs in the form of additional pumps, valves, gauges, and temperature control systems, in addition to the routine costs of filters.

Therefore, there is a need in the art for a method for removing impurities, including fusel oil, in a wide range of alcoholic beverages without additional costs and maintenance.

### SUMMARY

A method for removing a set of impurities in an alcoholic beverage is disclosed. In one embodiment, the steps include providing a water solution comprising approximately 96%, or less, of pure water and at least 4% or more of honey by volume, providing a spirit base comprising a set of impurities and at least 80% alcohol by volume, creating a mixture from approximately 50% the water solution by volume and approximately 50% the spirit base by volume, adding approximately 4% or more of a solids reactive surface by volume to create two phase colloidal mixture, adsorbing the set of impurities with the solids reactive surface, re-suspending the solids reactive surface in the mixture from the sedimentation to form a resultant product, adding approximately 1% of a set of extracts by volume to the resultant product to achieve designer taste, and separating the sedimentation from the resultant product. After separation of the two phases, the sediment contains impurities such as fusel oil, and yields a clear liquid final product suitable for consumption without additional purification.

### BRIEF DESCRIPTION OF THE DRAWINGS

In the detailed description presented below, reference will be made to the following drawing.

FIG. 1 is a flowchart of a method for removing impurities in alcoholic beverages of a preferred embodiment.

### DETAILED DESCRIPTION

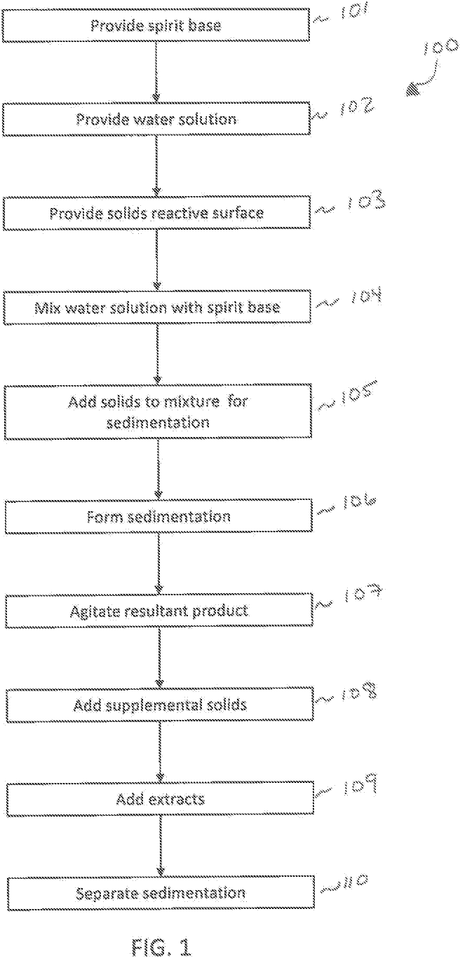

Referring to FIG. 1, method 100 for removing impurities in alcoholic beverages is described. In a preferred embodiment, any suitable mixing equipment known in the art may be used to perform this method.

Method 100 begins at step 101, where a spirit base is provided. In a preferred embodiment, the spirit base is any alcohol suitable for human consumption having at least eighty percent (80%) alcohol by volume (160 proof in the United States), that is mixed with equal amounts of a water solution as described below. For example, the spirit base is a clear high point alcohol such as vodka, rum, gin, or tequila. The components for a spirit base having at least eighty percent (80%) alcohol by volume is described in Table 1 below.

Table 1

Spirit Base Components

| | |
|---|---|
| Components | Amount (in approximate percentage by volume) |
| Water | 19% or less |
| Alcohol | 80% or more |
| Contaminants (Fusel Oil, etc.) | Up to and including 1% |

At step 102, a water solution is provided. In a preferred embodiment, the water solution is a mixture of water and honey in the amounts described in Table 1 below.

Table 2

Water Solution Components

| | |
|---|---|
| Components | Amount (in approximate percentage by volume) |
| Water | up to and including 96% |
| Honey | 4% or more |

In a preferred embodiment, the water solution includes approximately up to and including 96% water by volume, approximately 4% or more of honey by volume.

At step 103, a solids reactive surface is provided. In a preferred embodiment, the solids reactive surface is solid sugar. In this embodiment, the type of solid sugar will depend on the type of sprit base. For example, if the spirit base is high point vodka (80% alcohol by volume), then the solid sugar is approximately 4% or more by volume. In another example, if the spirit base is rum, then the solid sugar is approximately 4% or more by volume. In another example, if the spirit base is gin, then the solid sugar is 4% or more by volume. In another example, if the spirit base is tequila, then the solid sugar is 4% or more by volume.

At step 104, the water solution is mixed with the spirit base at a ratio of approximately fifty percent (50%) water solution by volume to approximately fifty percent (50%) spirit base. This step is performed using any suitable mixing equipment known in the art. In a preferred embodiment, the mixture of the water solution and the spirit base has an alcohol content of approximately forty percent (40%) alcohol by volume (80 proof in the United States). In a preferred embodiment, the mixture of the water solution and the spirit base is agitated for approximately one (1) hour.

At step 105, the solids reactive surface is added to the mixture of the water solution and the spirit base for sedimentation. This step is performed using any suitable mixing equipment known in the art. In one embodiment, approximately 4% or more of sugar by volume is added to the mixture.

At step 106, sedimentation of the solids reactive surface forms in the mixture of the water solution and spirit base to create a resultant product. In this step, impurities such as fusel oil are adsorbed on the solids reactive surface. In a preferred embodiment, the sedimentation process takes place for at least one (1) day. In this embodiment, the mixture of the water solution and the spirit base is agitated continuously for approximately twenty-four (24) hours or until the sugar dissolves.

At step 107, the resultant product is agitated to re-suspend the sedimentation of solids reactive surface in the mixture. This step is performed using any suitable mixing equipment known in the art.

At step 108, approximately 0.5% or more of supplemental solids reactive surface is added, per unit volume for efficient separation during one or more weeks, depending on how long it takes for the sediment to fully separate out. This step is performed using any suitable mixing equipment known in the art.

At step 109, approximately one percent (1%) or more of a set of extracts by volume is added to the resultant product. In a preferred embodiment, the set of extracts is extract of walnut dividers, or also known as the partition. The walnut divider is the portion inside of the walnut shell that separates the kernel or “meat” inside the walnut shell. In other embodiments, the set of extracts is a set of fruit extracts that include any number of desired fruits and/or plants. For example, pineapple, or hot pepper extract (for example Pimiento Roja.), or various herbs (for example anise) extract. Any type of fruit extract may be employed as desired. In other embodiments, a set of herbal extracts is employed. In a preferred embodiment, the set of herbal extracts is tincture extracts. Other known herbal extracts may be employed as desired.

At step 110, the sedimentation is separated from the resultant product, by pouring off the liquid, leaving behind the sediment.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. A method for removing impurities comprising the steps of:
creating a mixture from approximately 50% a water solution by volume and approximately 50% a spirit base by volume;
adding at least approximately 4% or more of a solids reactive surface by volume to the mixture;
creating a sedimentation of the solids reactive surface;
re-suspending the solids reactive surface in the mixture from the sedimentation to form a resultant product;
adding at least approximately 0.5% of a supplemental solids reactive surface by volume to the resultant product;
creating a supplemental sedimentation of the supplemental solids reactive surface;
adding at least approximately 1% of a set of extracts by volume to the resultant product; and,
separating the sedimentation and the supplemental sedimentation from the resultant product to form a final product.

2. The method of claim 1, further comprising the step of providing a spirit base having at least 80% alcohol by volume as the spirit base.

3. The method of claim 1, further comprising the step of creating the water solution from approximately 96% or less of water by volume and from approximately 4% or more of honey by volume.

4. The method of claim 1, further comprising the step of providing from approximately 4 % or more of sugar by volume as the solids reactive surface.

5. The method of claim 1, further comprising the step of providing from approximately 4 % or more of sugar by volume as the supplemental solids reactive surface.

6. The method of claim 1, wherein the step of creating a mixture from approximately 50% a water solution by volume and approximately 50% a spirit base by volume further comprises the step of agitating the mixture for approximately 1 day or more.

7. A method for removing a set of impurities comprising the steps of:
providing a water solution comprising from approximately 96% or less of water and from approximately 4% or more of honey by volume;
providing a spirit base comprising a set of impurities and at least 80% alcohol by volume;
creating a mixture from approximately 50% of the water solution by volume and approximately 50% of the spirit base by volume;
adding from approximately 4 % or more of a solids reactive surface by volume to the mixture;
re-suspending the solids reactive surface in the mixture from the sedimentation to form a resultant product;
adsorbing the set of impurities with the solids reactive surface;
adding at least approximately 0.5% of a supplemental solids reactive surface by volume to the resultant product;
adsorbing further the set of impurities with the supplement solids reactive surface;
adding at least approximately 1% of a set of extracts by volume to the resultant product; and,
separating the sedimentation and the supplemental sedimentation from the resultant product to form a final product.

8. The method of claim 7, further comprising the step of providing from approximately 4% or more of sugar by volume as the solids reactive surface.

9. The method of claim 7, further comprising the step of providing from approximately 0.5% or more of sugar by volume as the supplemental solids reactive surface.

10. The method of claim 7, wherein the step of creating a mixture from approximately 50% a water solution by volume and approximately 50% a spirit base by volume further comprises the step of agitating the mixture for approximately 1 day or more.

11. The method of claim 7, wherein the step of adsorbing the set of impurities with the solids reactive surface further comprises the step of agitating the mixture of the water solution, the spirit base, and the solids reactive surface for approximately 1 day or more.

12. The method of claim 7, wherein the step of adsorbing further the set of impurities with the supplemental solids reactive surface further comprises the step of agitating the mixture of the water solution, the spirit base, the solids reactive surface, and the supplemental solids reactive surface for approximately 1 day or more.
